(19) United States
(12) Patent Application Publication
(10) Pub. No.: US 2024/0114513 A1
(43) Pub. Date: Apr. 4, 2024

(54) LOW PRIORITY UPLINK INFORMATION RETRANSMISSION METHOD AND APPARATUS, DEVICE AND STORAGE MEDIUM

(71) Applicants: Beijing Xiaomi Mobile Software Co., Ltd., Beijing (CN); Beijing University of Posts and Telecommunications, Beijing (CN)

(72) Inventors: Yajun ZHU, Beijing (CN); Wei HONG, Beijing (CN); Jialin WU, Beijing (CN); Yong LI, Beijing (CN)

(73) Assignees: Beijing Xiaomi Mobile Software Co., Ltd., Beijing (CN); Beijing University of Posts and Telecommunications, Beijing (CN)

(21) Appl. No.: 18/270,358

(22) PCT Filed: Dec. 30, 2020
(86) PCT No.: PCT/CN2020/141672

§ 371 Date: Jun. 29, 2023

(51) Int. Cl. H04W 72/21; H04W 72/12; H04W 72/56

(52) U.S. Cl. CPC H04W 72/21; H04W 72/12; H04W 72/56

(57) ABSTRACT

A low priority uplink information retransmission method, includes: in response to uplink control information (UCI) having a transmission conflict, a base station using scheduling information of high priority UCI to deliver identifier information of low priority UCI to be retransmitted by a terminal in the UCI having the transmission conflict.

### CROSS REFERENCE TO RELATED APPLICATION

The present application is a U.S. National Stage of International Application No. PCT/CN2020/141672, filed on Dec. 30, 2020, the entire content of which is incorporated herein by reference for all purposes.

### BACKGROUND

Ultra reliable low latency communication (URLLC) is one of several different types of use cases supported by a 5G new radio (NR) standard, and regulated by a 3rd generation partnership project (3GPP). The URLLC will provide communication services in fields such as factory automation, autonomous driving, industrial Internet, a smart grid, or a robotic surgery.

### SUMMARY

According to a first aspect of examples of the disclosure, a low priority uplink information retransmission method is provided and includes:
in response to uplink control information (UCI) having a transmission conflict, delivering identifier information of low priority UCI to be retransmitted by a terminal in the UCI having the transmission conflict by using scheduling information of high priority UCI.

According to a second aspect of the examples of the disclosure, a low priority uplink information retransmission method is provided and includes:
receiving identifier information of low priority UCI to be retransmitted by a terminal, delivered through a base station by using scheduling information of high priority UCI, in UCI having a transmission conflict.

According to a third aspect of the examples of the disclosure, a device is provided, and at least includes a processor and a memory configured to store an executable instruction able to operate on the processor, where
when the processor is configured to operate the executable instruction, the executable instruction executes steps in the above any low priority uplink information retransmission method.

According to a fourth aspect of the examples of the disclosure, a non-transitory computer readable storage medium is provided, where the computer readable storage medium stores a computer executable instruction, and when the computer executable instruction is executed by a processor, steps in the above any low priority uplink information retransmission method are implemented.

### BRIEF DESCRIPTION OF THE DRAWINGS

The accompanying drawings here are incorporated into and form part of the specification, show examples that comply with the disclosure and are used for explaining principles of the examples of the disclosure together with the specification.

FIG. 1 is a schematic structural diagram of a wireless communication system shown according to an example.

FIG. 2 is a first schematic principle diagram of a low priority uplink information retransmission method shown according to an example.

FIG. 3 is a first flow diagram of a low priority uplink information retransmission method shown according to an example.

FIG. 4 is a second flow diagram of a low priority uplink information retransmission method shown according to an example.

FIG. 5 is a third flow diagram of a low priority uplink information retransmission method shown according to an example.

FIG. 6 is a fourth flow diagram of a low priority uplink information retransmission method shown according to an example.

FIG. 7 is a second schematic principle diagram of a low priority uplink information retransmission method shown according to an example.

FIG. 8 is a third schematic principle diagram of a low priority uplink information retransmission method shown according to an example.

FIG. 9 is a fourth schematic principle diagram of a low priority uplink information retransmission method shown according to an example.

FIG. 10 is a fifth schematic principle diagram of a low priority uplink information retransmission method shown according to an example.

FIG. 11 is a sixth schematic principle diagram of a low priority uplink information retransmission method shown according to an example.

FIG. 12 is a first structural block diagram of a low priority uplink information retransmission apparatus shown according to an example.

FIG. 13 is a second structural block diagram of a low priority uplink information retransmission apparatus shown according to an example.

FIG. 14 is a first schematic structural diagram of a device shown according to an example.

FIG. 15 is a second schematic structural diagram of a device shown according to an example.

### DETAILED DESCRIPTION

Examples are illustrated in detail here, instances of which are shown in the accompanying drawings. When the descriptions below relate to the accompanying drawings, the same numbers in different accompanying drawings indicate the same or similar elements unless otherwise indicated. The implementations described in the following examples do not represent all implementations consistent with the examples of the disclosure. On the contrary, they are merely examples of apparatuses and methods that are consistent with some aspects of the examples of the disclosure as detailed in the attached claims.

Terms used in the examples of the disclosure are just for the purpose of describing specific examples and are not aimed at limiting the examples of the disclosure. “One” and “the” of singular forms used in the examples of the disclosure and the appended claims are also aimed at including plural forms, unless that context clearly shows other meanings. It is also to be understood that a term “and/or” used in the disclosure refers to and includes any or all possible combinations of one or a plurality of relevant listed items.

It is to be understood that although terms of first, second, third, etc., may be adopted to describe various pieces of information in the examples of the disclosure, these pieces of information are not limited to these terms. The terms are just used to distinguish the same type of information from one another. For example, under the condition of not departing from the scope of the examples of the disclosure, first information also may be called second information, and similarly, the second information also may be called the first information. Depending on the context, for example, the words “if” and “like” used here may be explained as “at the time of . . . ” or “when . . . ” or “in response to determining.”

Examples of the disclosure relate to but are not limited to the field of wireless communications, in particular to a low priority uplink information retransmission method and apparatus, a device, and a storage medium.

To better describe any one example of the disclosure, the example of the disclosure takes an access control application scenario as an example for illustrative description.

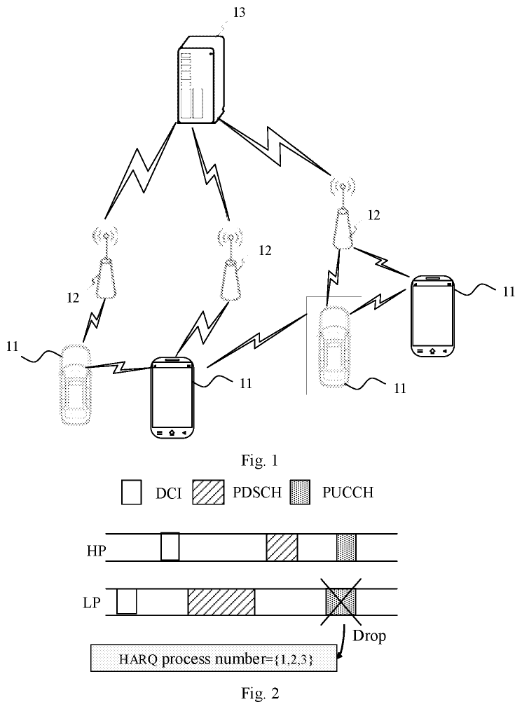

FIG. 1 shows a schematic structural diagram of a wireless communication system provided by an example of the disclosure. As shown in FIG. 1, the wireless communication system is a communication system based on a cellular mobile communication technology. The wireless communication system may include a plurality of terminals 11 and a plurality of base stations 12.

The terminals 11 may refer to a device providing voice and/or data connectivity for a user. The terminals 11 may communicate with one or more core networks via a radio access network (RAN), and the terminals 11 may be Internet of Things terminals, such as sensor devices, mobile phones (or called “cellular” phones), and computers with the Internet of Things terminals, for example, may be stationary, portable, pocket, handheld, computer built-in, or vehicle-mounted apparatuses, for example, a station (STA), a subscriber unit, a subscriber station, a mobile station, a mobile, a remote station, an access point, a remote terminal, an access terminal, a user terminal, a user agent, a user device or a user terminal (user equipment). Or, the terminals 11 may also be devices of an unmanned aerial vehicle. Or, the terminals 11 may also be vehicle-mounted devices. For example, trip computers with a wireless communication function or wireless terminals externally connected with the trip computers are examples of vehicle-mounted devices. Or, the terminals 11 may also be infrastructure, for example, may be street lamps, signal lamps or other infrastructure with a wireless communication function.

The base stations 12 may be network side devices in the wireless communication system. The wireless communication system may be a 4th generation mobile communication (4G) system, also known as a long term evolution (LTE) system; or the wireless communication system may also be a 5G system, also known as a new radio (NR) system or a 5G NR system. Or, the wireless communication system may also be a next-generation system of the 5G system. An access network in the 5G system may be called a new generation-radio access network (NG-RAN).

The base stations 12 may be evolution base stations (eNBs) adopted in the 4G system. Or, the base stations 12 may also be base stations (gNBs) adopting a centralized distributed architecture in the 5G system. When the base stations 12 adopt the centralized distributed architecture, the base stations generally include a central unit (CU) and at least two distributed units (DUs). Protocol stacks of a packet data convergence protocol (PDCP) layer, a radio link control (RLC) layer and a media access control (MAC) layer are set in the central unit; and a protocol stack of a physical (PHY) layer is set in each distributed unit. Specific implementations of the base stations 12 are not limited by the examples of the disclosure.

A wireless connection may be built between the base stations 12 and the terminals 11 through wireless radios. In different examples, the wireless radios are wireless radios based on the 4th generation mobile communication network technology (4G) standard; or the wireless radios are wireless radios based on the 5th generation mobile communication network technology (5G) standard, for example, the wireless radios are new radios; or the wireless radios may also be wireless radios based on the next-generation mobile communication network technology standard of the 5G.

In some examples, an end to end (E2E) connection may also be built between the terminals 11, for example, vehicle to vehicle (V2V) communication, vehicle to infrastructure (V2I) communication, vehicle to pedestrian (V2P) communication and other scenarios in vehicle to everything (V2X).

In some examples, the above wireless communication system may further include a network management device 13.

The plurality of base stations 12 are respectively connected with the network management device 13, where the network management device 13 may be a core network device in the wireless communication system, for example, the network management device 13 may be a mobility management entity (MME) in an evolved packet core (EPC). Or the network management device may also be other core network devices, such as a serving gateway (SGW), a public data network gateway (PGW), a policy and charging rules function (PCRF) or a home subscriber server (HSS). For an implementation form of the network management device 13, the examples of the disclosure are non-limiting.

URLLC is one of several different types of use cases supported by the 5G NR standard, and stipulated by the 3GPP. The URLLC will provide a plurality of advanced services for a low-latency sensitive networking device, such as factory automation, autonomous driving, industrial Internet, a smart grid or a robotic surgery. Other services to be supported by the 5G include an enhanced mobile broadband (eMbb) and massive machine type communication (mMTC). The eMBB will provide high-bandwidth Internet access for wireless connectivity, large-scale video streaming and virtual reality. The mMTC is used to support network access of sensing, metering, and monitoring devices.

A key feature of the URLLC is low latency (LL), which is very important for devices like autonomous driving or the robotic surgery. The low latency allows optimized networks to process the incredibly large number of data with minimal latency, and the networks need to adapt to the large number of data changing in real time. The new URLLC wireless connection guarantees wait time of 1 ms or less. The design of low latency and high reliability services involves several technologies: integrated frame structures, shorter cycles, efficient control and data resource sharing, based on unauthorized uplink transmission and highly reliable channel coding schemes.

In the URLLC, services with different priorities of transmission rights exist, and when a resource conflict occurs between a high priority service and a low priority service, data related to the low priority service are dropped.

In the URLLC, a high priority service has the right to be transmitted before a lower priority service. In some examples, when resource conflicts occur between high priority UCI (HP-UCI) and low priority UCI (LP-UCI), all LP-UCI information may be dropped. As shown in FIG. 2, since LP-UCI and HP-UCI transmissions are triggered at the same time after the transmission of DCI and physical downlink shared channel (PDSCH), feedback information corresponding to HARQ process numbers being 1, 2, and 3 in the LP-UCI will be dropped and is no longer transmitted at the moment. In this case, the performance of LP services is greatly affected, especially in the case that LP-HARQ feedback information is dropped.

Those skilled in the art may understand that the technical solutions may be implemented in isolation or may also be implemented together with any one of other technical solutions in the examples of the disclosure, which is not limited in the examples of the disclosure.

The disclosure provides a low priority uplink information retransmission method and apparatus, a device and a storage medium.

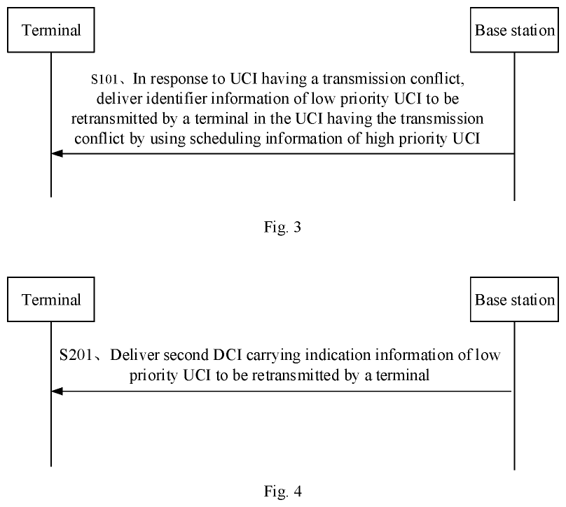

As shown in FIG. 3, an example of the disclosure provides a low priority uplink information retransmission method, and the method is applied to a base station and includes:

step S101, in response to UCI having a transmission conflict, identifier information of low priority UCI to be retransmitted by a terminal in the UCI having the transmission conflict is delivered by using scheduling information of high priority UCI.

In the example of the disclosure, the terminal may be various UE with a communication function and includes a production device, a vehicle-mounted device, a smart robot, various mobile phones, etc.

For instance, since the UCI reported by the terminal is determined by the base station as a time-frequency resource location for transmission, the base station can know a conflict situation of UCI transmission in advance before receiving the UCI. If the base station determines that there is the UCI having the transmission conflict, it can inform the terminal which UCI needs the terminal to perform retransmission.

In the example of the disclosure, the identifier information of the UCI may be information such as a process number contained in the UCI itself and may also be the identifier information obtained by numbering the UCI to be retransmitted by the base station. The UCI to be retransmitted by the terminal at least includes HARQ information to be retransmitted.

In the example of the disclosure, when the UCI having the transmission conflict is generated, the UCI having the transmission conflict may be divided into high priority UCI and low priority UCI according to a service priority.

In the example of the disclosure, when the base station may schedule the high priority UCI, the scheduling information is used for delivering the identifier information corresponding to the low priority UCI. For example, when the base station performs scheduling through downlink control information, the above identifier information is carried in the downlink control information.

Accordingly, when there is the UCI having the transmission conflict, the base station may inform the terminal of the identifier of the UCI needing to be retransmitted, so as to facilitate retransmission of the UCI by the terminal. Accordingly, on one hand, the base station and the terminal have consistent information about whether there is the transmission conflict and which UCI needs the terminal to perform retransmission, so as to reduce information missing caused by information inconsistency; and on the other hand, the terminal conveniently retransmits the UCI based on instructions of the base station, compared with retransmitting information of all processes at a time, the redundancy of retransmission information is reduced, and resources are saved.

The disclosure provides an uplink information transmission method, in response to uplink control information (UCI) having a transmission conflict, delivering identifier information of low priority UCI to be retransmitted by a terminal in the UCI having the transmission conflict by using scheduling information of high priority UCI includes:
in response to the UCI having the transmission conflict, when it is determined that the low priority UCI is dropped, first downlink control information (DCI) carrying the identifier information of the low priority UCI is delivered, where the first DCI is used for scheduling the high priority UCI.

In the example of the disclosure, the base station delivers the first DCI to the terminal for scheduling the high-priority UCI, since the base station knows that the conflicting low priority UCI needs to be retransmitted by the terminal at the moment, the base station can number the low priority UCI to be retransmitted by the terminal, that is, the identifier information corresponding to the low priority UCI is determined. Then, the base station may carry the identifier information through the first DCI and deliver it to the terminal. The terminal may perform uplink transmission based on the scheduling of the base station, and determine the UCI to be retransmitted by the terminal based on the first DCI used for scheduling the uplink transmission, and then perform retransmission.

In this way, the base station and terminal reach a consensus on the UCI to be retransmitted, so as to reduce information missing or unnecessary retransmission.

The disclosure provides the uplink information transmission method, the first DCI includes a first DAI field, and the first DAI field is a field added to the first DCI and used for carrying the identifier information of the low priority UCI.

The first DCI is used for scheduling the high priority UCI, so that the first DCI contains scheduling information of the high priority UCI, for example, an identifier of the high priority UCI and a configured time-frequency resource.

In the example of the disclosure, the first DAI field is added to the first DCI, and the field is used to carry the identifier information of the low priority. Accordingly, the terminal can know which low priority UCI needs to be retransmitted by reading the first DAI field in the first DCI.

In the example of the disclosure, the first DCI is used for scheduling the high priority UCI, so the first DAI field may be carried in the first DCI corresponding to each high-priority UCI having the transmission conflict.

Accordingly, when the terminal receives the first DCI for scheduling the high priority UCI, the terminal can know whether there is corresponding low priority UCI that needs to be retransmitted, and then complete the retransmission.

The disclosure provides the uplink information transmission method, further including:
the high priority UCI scheduled based on the first DCI is received.

After scheduling the high priority UCI is delivered to the terminal, the base station will receive the high priority UCI reported by the terminal based on the first DCI. Meanwhile, the base station will deliver DCI for scheduling the low priority UCI, so that the base station will also receive the low priority UCI reported by the terminal. If there is the transmission conflict between the high priority UCI and the low priority UCI, the terminal transmits the high priority UCI and drops the low priority UCI. At the moment, the dropped low priority UCI needs to be retransmitted by the terminal.

The disclosure provides an uplink information transmission method, as shown in FIG. 4, including:
step S201: second DCI carrying indication information of the low priority UCI to be retransmitted by the terminal is delivered, where the second DCI is used for triggering the terminal to retransmit the low priority UCI.

For instance, the second DCI is used for triggering the terminal to report a codebook of one-shot retransmission, where the second DCI carries the indication information, the indication information is used for indicating information related to the UCI to be retransmitted by the terminal and for the terminal to confirm whether the UCI to be retransmitted is consistent with the UCI expected to be retransmitted by the base station. For example, the indication information may be used for indicating the number of UCI to be retransmitted by the terminal, or used for indicating the identifier of the UCI to be retransmitted by the terminal, or used for indicating the time-frequency resource configured for the UCI to be retransmitted by the terminal, etc.

In other words, when the base station triggers the terminal to perform retransmission through the second DCI, it informs the terminal of carried retransmitted UCI related information through the indication information. In this way, the base station and the terminal can reach a consensus on the UCI to be retransmitted by the terminal through the indication information to reduce the information missing or unnecessary retransmission caused by the information inconsistency between the base station and the terminal.

The disclosure provides the uplink information transmission method. The second DCI includes a second DAI field, and the second DAI field is a field added to the second DCI and used for carrying the indication information.

In the example of the disclosure, the second DAI field is added to the second DCI, and carries the above indication information.

In one example, the DAI field is used for informing the UE of how many subframes contain downlink transmission in an HARQ feedback window. For instance, the DAI field may be used for informing the UE of how many UCI codebooks need to be retransmitted due to the transmission conflict.

The disclosure provides the uplink information transmission method. The indication information includes at least one of the following:
the number of low priority UCI to be retransmitted by the terminal; or
PUCCH resource information configured for the low priority UCI to be retransmitted by the terminal.

The above indication information may include the number of UCI to be retransmitted by the terminal, so the terminal obtains the identifier information of the UCI to be retransmitted by the terminal based on scheduling information of the high priority UCI that is the first DCI and determines the number of UCI to be retransmitted based on the indication information, so that the base station and the terminal reach a consensus on the retransmitted codebook.

In addition, the above indication information may also include PUCCH resource configuration for retransmission by the terminal, and the terminal may use the configured PUCCH resource to retransmit the above UCI.

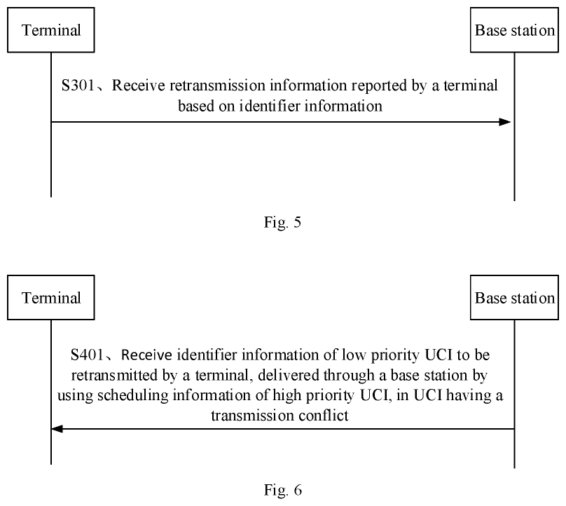

The disclosure provides the uplink information transmission method, as shown in FIG. 5, including:
step S301, retransmission information reported by the terminal based on the identifier information is received, where the retransmission information at least includes the low priority UCI to be retransmitted by the terminal.

After the terminal determines the low priority UCI to be retransmitted according to the identifier information, the terminal may perform retransmission, so that the base station may receive the retransmission information reported by the terminal based on the identifier information.

For instance, the retransmission information at least includes the UCI to be retransmitted determined based on the identifier information, and in addition, the retransmission information may also include some other information, for example, an identifier facilitating identifying of the retransmission information by the base station, number information and some parity information.

The disclosure provides the uplink information transmission method, where the retransmission information further includes:
bitmap information corresponding to the UCI to be retransmitted by the terminal, where the bitmap information is used for indicating whether the terminal receives the identifier information corresponding to the low priority UCI to be retransmitted by the terminal.

In the example of the disclosure, since the identifier information may be obtained by numbering by the base station through certain rules, for example, the identifier information may be numbered in an order starting from 0, and represented by a binary system as 00, 01, 10, and so on. If the identifier information received by the terminal is discontinuous, there may be missing detection. As a result, the terminal may use the bitmap information to represent whether the terminal receives the identifier information corresponding to each UCI to be retransmitted and report the corresponding retransmitted UCI. In this way, the base station may determine whether the received terminal retransmission information includes all the UCI to be retransmitted, whether there is other redundant information, whether there is missing transmission, etc. through the bitmap information, so as to perform further data transmission.

The disclosure provides the uplink information transmission method, where the number of characters of the bitmap information is equal to the number of the low priority UCI to be retransmitted by the terminal.

For instance, the bitmap information received by the base station may include the terminal marking the UCI corresponding to each number, for example, if the terminal receives the DCI containing marking information of 00, 01, and 10, the terminal marks 1 respectively in the 3-bit bitmap information during retransmission to represent that the corresponding identifier information is received, that is, the bitmap information is 111. In addition, the retransmission information reported by the terminal contains codebooks corresponding to three pieces of UCI.

If the terminal receives the DCI containing the marking information of 00 and 10, the terminal misses detection of the DCI containing the marking information of 01. Then, at the moment, the 3-bit bitmap information reported by the terminal during retransmission is 101, that is, informing the base station that the identifier information of second UCI is not received, and the UCI corresponding to 00 and 10 is retransmitted.

Accordingly, the base station may obtain whether the terminal has the missing detection condition through the bitmap information and determines the UCI retransmitted by the terminal and the identifier information corresponding to the UCI, so misunderstanding cannot be generated.

As shown in FIG. 6, the example of the disclosure provides the low priority uplink information retransmission method, applied to the terminal and including:
step S401: the identifier information of the low priority UCI to be retransmitted by the terminal, delivered through the base station by using the scheduling information of the high priority UCI, in the UCI having the transmission conflict is received.

In the example of the disclosure, the identifier information of the UCI may be information such as a process number contained in the UCI itself and may also be the identifier information obtained by numbering the UCI to be retransmitted by the base station.

After receiving the identifier information delivered by the base station, the terminal may determine which UCI is the UCI to be retransmitted by the terminal instead of retransmitting all low priority UCI. In this way, on the one hand, the efficiency of retransmission is improved, and unnecessary retransmission, missing transmission and other conditions are reduced. On the other hand, the terminal and the base station can reach a consensus on the UCI to be retransmitted to reduce the inconsistency between the retransmission information and retransmission information to be received by the base station due to the missing detection of the terminal and other conditions.

The disclosure provides the uplink information transmission method, where the identifier information of the low priority UCI to be retransmitted by the terminal, delivered through the base station by using the scheduling information of the high priority UCI, in the UCI having the transmission conflict being received includes:
the first DCI carrying the identifier information of the low priority UCI is received, where the first DCI is used for scheduling the high priority UCI.

If the high priority UCI and the low priority UCI are transmitted to the base station at the same time, the base station preferably receives the high priority UCI, so that the base station may determine the low priority UCI as the UCI to be retransmitted by the terminal.

In the example of the disclosure, the terminal receives the first DCI to schedule the high priority UCI. Since the base station knows in advance that the low priority UCI having the conflict needs to be retransmitted by the terminal, the identifier information corresponding to the low priority UCI is carried in the first DCI. The terminal may perform uplink transmission based on the scheduling of the base station, and determine the UCI to be retransmitted by the terminal based on the first DCI used for scheduling the uplink transmission, and then perform retransmission.

Accordingly, the terminal and the base station reach a consensus on the UCI to be retransmitted to reduce information missing or unnecessary retransmission.

The disclosure provides the uplink information transmission method, where the first DCI includes a first DAI field, and the first DAI field is a field added to the first DCI and used for carrying the identifier information corresponding to the low priority UCI.

In the example of the disclosure, the first DCI carries the first DAI field, and the terminal may obtain the identifier information corresponding to the low priority UCI through the first DAI

### FIELD

The disclosure provides the uplink information transmission method, further including:
the high priority UCI is reported based on the first DCI; and
the low priority UCI is dropped and the low priority UCI is used as the low priority UCI to be retransmitted by the terminal according to the identifier information carried by the first DCI.

Since the first DCI is the downlink control information used for scheduling the high priority UCI, the terminal may report the corresponding high priority UCI based on the scheduling of the first DCI.

In addition, the first DIC carries the identifier information of the low priority UCI to be retransmitted by the terminal, so that the terminal may retransmit the low priority UCI based on the identifier information.

The disclosure provides the uplink information transmission method, further including:
second DCI carrying indication information of the low priority UCI to be retransmitted by the terminal is received, and the second DCI is used for triggering the terminal to retransmit the low priority UCI.

For instance, the second DCI is used for triggering the terminal to report a codebook of one-shot retransmission, where the second DCI carries the indication information, and the indication information is used for indicating information related to the UCI to be retransmitted by the terminal. For example, the indication information may be used for indicating the number of UCI to be retransmitted by the terminal, or used for indicating the identifier of the UCI to be retransmitted by the terminal, or used for indicating the time-frequency resource configured for the UCI to be retransmitted by the terminal, etc.

As a result, the terminal may retransmit the UCI based on the received second DCI. Since the second DCI carries the indication information, so the terminal may further determine whether the UCI retransmitted by the terminal is consistent with the UCI to be retransmitted determined by the base station, based on the indication information.

The disclosure provides the uplink information transmission method. The second DCI includes a second DAI field, and the second DAI field is a field added to the second DCI and carries the indication information.

For instance, the second DAI field is used for carrying the above indication information, for example, the number carried by a few characters identifies how many UCI codebooks need to be retransmitted due to the transmission conflicts.

The disclosure provides the uplink information transmission method. The indication information includes at least one of the following:
the number of low priority UCI to be retransmitted by the terminal; or
PUCCH resource information configured for the low priority UCI to be retransmitted by the terminal.

The above indication information may include the number of UCI to be retransmitted by the terminal, so the terminal obtains the identifier information of the UCI to be retransmitted by the terminal based on scheduling information of the high priority UCI that is the first DCI, and determines the number of UCI to be retransmitted based on the indication information, so that the base station and the terminal reach a consensus on the retransmitted codebook.

In addition, the above indication information may also include PUCCH resource configuration for retransmission by the terminal, and the terminal may use the configured PUCCH resource to retransmit the above UCI.

The disclosure provides the uplink information transmission method, further including:
retransmission information is reported based on the identifier information, where the retransmission information at least includes the low priority UCI retransmitted by the terminal.

After the terminal determines the UCI to be retransmitted according to the identifier information, the terminal may perform retransmission, and certainly after the terminal receives the second DCI used for triggering the terminal to perform retransmission delivered by the base station, the terminal reports the retransmission information based on the identifier information.

For instance, the retransmission information at least includes the UCI to be retransmitted determined based on the identifier information, and in addition, the retransmission information may also include some other information, for example, an identifier facilitating identifying of the retransmission information by the base station, number information and some parity information.

The disclosure provides the uplink information transmission method, where the retransmission information further includes:
bitmap information corresponding to the low priority UCI retransmitted by the terminal, where the bitmap information is used for indicating whether the terminal receives the identifier information of the low priority UCI to be retransmitted by the terminal.

In the example of the disclosure, since the identifier information may be obtained by numbering by the base station through certain rules, for example, the identifier information may be numbered in an order starting from 0, and represented by a binary system as 00, 01, 10, and so on. If the identifier information received by the terminal is discontinuous, there may be missing detection. As a result, the terminal may use the bitmap information to represent whether the terminal receives the identifier information corresponding to each UCI to be retransmitted and report the corresponding retransmitted UCI. In this way, the base station may determine whether the received terminal retransmission information includes all the UCI to be retransmitted, whether there is other redundant information, whether there is missing transmission, etc. through the bitmap information, so as to perform further data transmission.

The disclosure provides the uplink information transmission method, where the number of characters of the bitmap information is equal to the number of the low priority UCI to be retransmitted by the terminal.

For instance, the terminal may mark the UCI corresponding to each number, for example, if the terminal receives the DCI containing marking information of 00, 01, and 10, the terminal marks 1 respectively in the 3-bit bitmap information during retransmission to represent that the corresponding identifier information is received, that is, the bitmap information is 111. In addition, the retransmission information reported by the terminal contains codebooks corresponding to three pieces of UCI.

If the terminal receives the DCI containing the marking information of 00 and 10, the terminal misses detection of the DCI containing the marking information of 01. Then, at the moment, the 3-bit bitmap information reported by the terminal during retransmission is 101, that is, informing the base station that the identifier information of second UCI is not received, and the UCI corresponding to 00 and 10 is retransmitted.

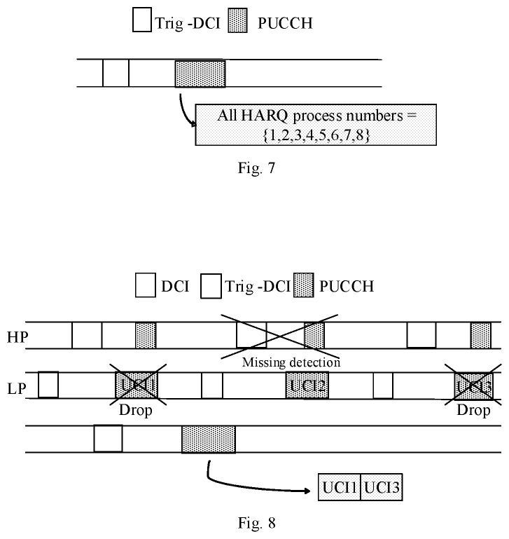

The example of the disclosure further provides the following examples:
in one example, a one-shot codebook mechanism is used to transmit the HARQ information again. According to a one-shot codebook rule, when the base station triggers one-shot codebook feedback through Trig-DCI, that is the above second DCI, the UE will arrange ACK/NACK information corresponding to all HARQ processes in an ascending order according to the process numbers. As shown in FIG. 7, the dropped HARQ information with the process numbers as 1, 2, and 3 is contained in a one-shot codebook to be fed back.

However, if the dropped HARQ information merely corresponds to part of HARQ processes in this way, ACK/NACK (determining response/denying response) information of other HARQ processes still needs to be fed back in accordance with the one-shot codebook rule, resulting in redundancy. As shown in FIG. 7, the non-dropped HARQ information with the process numbers as 4-8 is also contained in the one-shot codebook for feedback. In addition, a semi-static scheduling (SPS) release process does not have a corresponding process number, so it cannot be contained in the one-shot codebook.

If a feedback scope of the one-shot codebook needs to be limited in the dropped HARQ process, the possible problem of the UE missing detection of the HP-DCI will occur. As shown in FIG. 8, the base station expects to receive information of UCI 1, 2, and 3 after triggering the retransmission of the HARQ according to its own scheduling situation. However, on a UE side, the UE does not know that UCI2 is to be dropped because the detection of the second HP-DCI is missed. After receiving the trigger of the DCI, the UE will merely feed back the UCI 1 and 3, resulting in inconsistent understanding on the retransmitted codebook by the base station and the UE.

In the example of the disclosure, by adding a drop downlink allocation index (Drop-DAI (D-DAI)) field to the DCI of scheduling HP data, that is the above first DAI field. The base station numbers the dropped LP codebook and sends the number to the UE. When the UE encounters the codebook dropping situation, it caches the dropped codebook (including the HARQ information of the semi-static scheduling release process without a corresponding process number) and waits for the chance of retransmission. A total drop downlink allocation index (Total-Drop-DAI (TD-DAI)) field is added to Trig-DCI that triggers the one-shot codebook, that is, the above second DAI field indicates the total number of dropped codebooks and clearly specifies the corresponding PUCCH resource. When the base station sends Trig-DCI, that is, the above second DCI triggers the retransmission of the HARQ, the UE transmits the cached codebook on the specified resource in one shot according to the received number.

As a result, the solution may ensure that a base station end and a client have the consistent understanding for the codebook content and solve the problem caused by DCI missing detection. Compared with an existing solution, redundant information in an HARQ retransmission codebook is eliminated, and retransmission of feedback information corresponding to the semi-static scheduling release process is supported. The example of the disclosure includes the two following aspects, that is, numbering a dropped codebook during scheduling and feeding back the dropped codebook in one shot during triggering.

Numbering the dropped codebook during scheduling: the D-DAI field is added to the DCI scheduling the HP data. The base station may already anticipate the possible UCI conflict when scheduling the HP data, so that the dropped LP codebook may be numbered and the UE is informed through the D-DAI field in the DCI of the HP. The UE needs to cache the dropped codebook when it encounters the condition that the codebook is dropped and waits for the chance to transmit it again.

Feeding back the dropped codebook in one shot during triggering: in the Trig-DCI that triggers the one-shot codebook, the TD-DAI field is added to indicate the total number of dropped codebooks and explicitly specify the corresponding PUCCH resource. When the base station sends the Trig-DCI to trigger the retransmission of the HARQ, the UE transmits the cached codebook in one shot according to a received number. The retransmitted codebook first contains TD-DAI bits during synthesis, and each bit corresponds to a dropped LP codebook. A value of 1 means that the UE receives the corresponding HP DCI and will contain the corresponding LP codebook in the subsequent content of the retransmitted codebook.

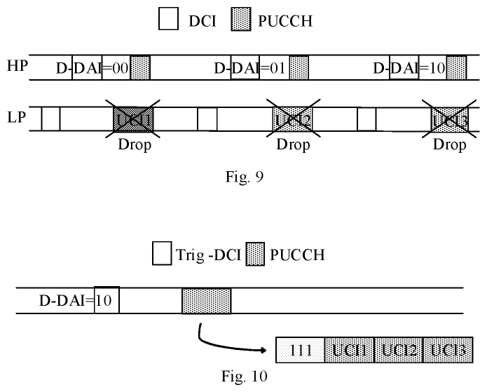

As shown in FIG. 9, three consecutive pieces of LP-UCI are dropped due to resource conflicts. In the corresponding HP-DCI, values of the D-DAI are 00, 01, and 10, respectively, and the values increase in sequence, respectively representing the numbers of the dropped UCI 1, 2, and 3. Meaning of the value of D-DAI: D-DAI=11 represents that there is no UCI conflict, and D-DAI=00/01/10 represents the numbers corresponding to the dropped LP codebooks.

As shown in FIG. 10, in the Trig-DCI, the value of TD-DAI is 10, representing that the total number of dropped UCI is 3. Therefore, when the retransmitted codebook is synthesized, it first contains 3 bits with the value of 1, representing that the UE receives the corresponding HP DCI, and will include the codebooks corresponding to UCI 1, 2, and 3 in the subsequent content of the retransmitted codebook.

It needs to be noted that the above mode supports feedback of the HARQ information of SPS Release: when the UE encounters codebook dropping, the codebook is cached, including the HARQ information of the semi-static scheduling release process without a corresponding process number. When the base station triggers the retransmission, the HARQ information of the semi-static scheduling release process is fed back again along with the cached codebook.

In addition, for determining of the PUCCH resource: in addition to traditional PUCCH resources-related parameters, a PUCCH resource set ID is also be contained in the Trig-DCI to eliminate the problem of inconsistent resource selection caused by load changes caused by different numbers of codebooks between the base station and the UE. If there is any resource left, 0 can be added after the retransmitted codebook.

In addition to the above scenario, the example of the disclosure may avoid a problem of the fuzzy HARQ feedback codebook between the base station and the user in the case that UE misses detection of the HP-DCI. As shown in FIG. 11, the UE does not know that the second LP codebook has been dropped due to the missing detection of the DCI. When synthesizing the retransmission codebook, the UE will set a second bit corresponding to the second LP codebook as 0 in the first 3 bit bitmap, and directly cascade the codebooks UCI1 and UCI3 that UE considers to be dropped in subsequent codebooks. After receiving the retransmission codebook, the base station first reads the first 3 bit bitmap and divides the subsequent retransmission codebook according to the size of the codebook corresponding to the value of 1 in the bitmap, thus solving the problem caused by DCI missing detection.

Through the technical solution of the examples of the disclosure, an enhanced one-shot codebook mechanism performs retransmission aimed at dropped low priority HARQ information. In the DCI scheduling the HP data, the D-DAI field is added to number the dropped LP codebook. In the Trig-DCI that triggers the one-shot codebook, the TD-DAI field is added to indicate the total number of dropped codebooks. When the base station sends the Trig-DCI to trigger the retransmission of the HARQ, the UE transmits the cached codebook on the specified resource in one shot according to the received number. This mechanism eliminates the redundant information in the HARQ retransmission codebook and meanwhile solves the problem that the base station and the client have inconsistent understanding for the codebook content possibly caused by the missing detection of the DCI, and supports the retransmission of the feedback information corresponding to the semi-static scheduling release process. On the one hand, the redundant information in the HARQ retransmission codebook is eliminated, and the problem caused by the missing detection of the DCI is solved. At the same time, the HARQ retransmission codebook contains the feedback corresponding to the semi-static scheduling release process.

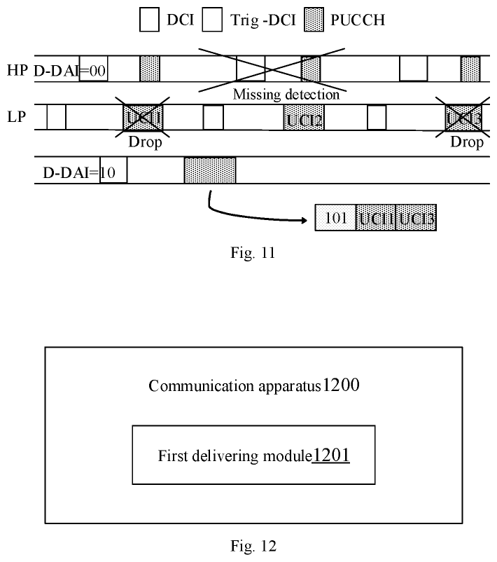

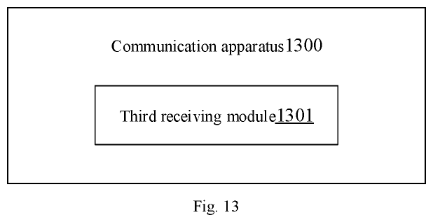

As shown in FIG. 12, an example of the disclosure further provides a low priority uplink information retransmission apparatus 1200, applied to a base station and including:
a first delivering module 1201, configured to in response to uplink control information (UCI) having a transmission conflict, deliver identifier information of low priority UCI to be retransmitted by a terminal in the UCI having the transmission conflict by using scheduling information of high priority UCI.

The example of the disclosure further provides the low priority uplink information retransmission apparatus, where the first delivering module includes:
a delivering submodule, configured to in response to the UCI having the transmission conflict, deliver first DCI carrying the identifier information of the low priority UCI, where the first DCI is used for scheduling the high priority UCI.

The example of the disclosure further provides the low priority uplink information retransmission apparatus, where the first DCI includes a first DAI field, and the first DAI field is a field added to the first DCI and used for carrying the identifier information of the low priority UCI.

The example of the disclosure further provides the low priority uplink information retransmission apparatus, further including:
a first receiving module, configured to receive the high priority UCI scheduled based on the first DCI.

The example of the disclosure further provides the low priority uplink information retransmission apparatus, further including:
a second delivering module, configured to deliver second DCI carrying indication information of the low priority UCI to be retransmitted by the terminal, where the second DCI is used for triggering the terminal to retransmit the low priority UCI.

The example of the disclosure further provides the low priority uplink information retransmission apparatus, where the second DCI includes a second DAI field, and the second DAI field is a field added to the second DCI and used for carrying the indication information.

The example of the disclosure further provides the low priority uplink information retransmission apparatus, where the indication information includes at least one of the following:
the number of low priority UCI to be retransmitted by the terminal; or
PUCCH resource information configured for the low priority UCI to be retransmitted by the terminal.

The example of the disclosure further provides the low priority uplink information retransmission apparatus, further including:
a second receiving module, configured to receive retransmission information reported by the terminal based on the identifier information, where the retransmission information at least includes the low priority UCI to be retransmitted by the terminal.

In some examples, the retransmission information further includes:
bitmap information corresponding to the low priority UCI to be retransmitted by the terminal, where the bitmap information is used for indicating whether the terminal receives the identifier information corresponding to the low priority UCI to be retransmitted by the terminal.

The example of the disclosure further provides the low priority uplink information retransmission apparatus, where the number of characters of the bitmap information is equal to the number of the low priority UCI to be retransmitted by the terminal.

As shown in FIG. 13, an example of the disclosure further provides a low priority uplink information retransmission apparatus 1300, applied to a terminal and including:
a third receiving module 1301, configured to receive identifier information of low priority UCI to be retransmitted by a terminal, delivered through a base station by using scheduling information of high priority UCI, in UCI having a transmission conflict.

The example of the disclosure further provides the low priority uplink information retransmission apparatus, where the third receiving module includes:
a receiving submodule, configured to receive first DCI carrying the identifier information of the low priority UCI, where the first DCI is used for scheduling the high priority UCI.

In some examples, the first DCI includes a first DAI field, and the first DAI field is a field added to the first DCI and used for carrying the identifier information corresponding to the low priority UCI.

The example of the disclosure further provides the low priority uplink information retransmission apparatus, further including:
a first reporting module, configured to report the high priority UCI based on the first DCI; and
a dropping module, configured to drop the low priority UCI and use the low priority UCI as the low priority UCI to be retransmitted by the terminal according to the identifier information carried by the first DCI.

The example of the disclosure further provides the low priority uplink information retransmission apparatus, further including:
a fourth receiving module, configured to receive second DCI carrying indication information of the low priority UCI to be retransmitted by the terminal, where the second DCI is used for triggering the terminal to retransmit the low priority UCI.

The example of the disclosure further provides the low priority uplink information retransmission apparatus, where the second DCI includes a second DAI field, and the second DAI field is a field added to the second DCI and carries the indication information.

In some examples, the indication information includes at least one of the following:
the number of low priority UCI to be retransmitted by the terminal; or
PUCCH resource information configured for the low priority UCI to be retransmitted by the terminal.

The example of the disclosure further provides the low priority uplink information retransmission apparatus, further including:
a second reporting module, configured to report retransmission information based on the identifier information, where the retransmission information at least includes the low priority UCI retransmitted by the terminal.

The example of the disclosure further provides the low priority uplink information retransmission apparatus, where the retransmission information further includes:
bitmap information corresponding to the low priority UCI retransmitted by the terminal, where the bitmap information is used for indicating whether the terminal receives the identifier information of the low priority UCI to be retransmitted by the terminal.

The example of the disclosure further provides the low priority uplink information retransmission apparatus, where the number of characters of the bitmap information is equal to the number of the low priority UCI to be retransmitted by the terminal.

With respect to the apparatus in the above examples, the specific mode in which each module performs an operation has been described in detail in the example related to the method and will not be illustrated in detail here.

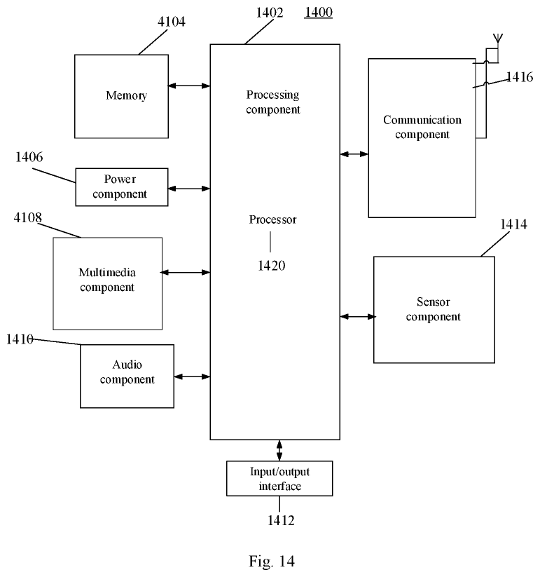

FIG. 14 is a structural block diagram of a communication device provided by an example of the disclosure. The communication device may be a terminal. For example, the communication device 1400 may be a mobile phone, a computer, a digital broadcasting user device, a messaging device, a game console, a tablet device, a medical device, a fitness device, a personal digital assistant, etc.

Referring to FIG. 14, the communication device 1400 may include at least one of following components: a processing component 1402, a memory 1404, a power component 1406, a multimedia component 1408, an audio component 1410, an input/output (I/O) interface 1412, a sensor component 1414, or a communication component 1416.

The processing component 1402 typically controls the overall operation of the communication device 1400, such as operations associated with display, a telephone call, data communication, a camera operation, and a recording operation. The processing component 1402 may include at least one processor 1420 to execute instructions to complete all or part of the steps of the above method. In addition, the processing component 1402 may include at least one module to facilitate interactions between the processing component 1402 and other components. For example, the processing component 1402 may include a multimedia module to facilitate the interaction between the multimedia component 1408 and the processing component 1402.

The memory 1404 is configured to store various types of data to support an operation on the communication device 1400. Examples of such data include instructions for any application program or methods operating on the communication device 1400, contact data, phone book data, messages, pictures, videos, etc. The memory 1404 may be implemented by any type of volatile or non-volatile storage device or a combination of them, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or an optical disc.

The power component 1406 provides power to the various components of the communication device 1400. The power component 1406 may include a power management system, at least one power supply, and other components associated with generating, managing, and distributing power for the communication device 1400.

The multimedia component 1408 includes a screen providing an output interface between the communication device 1400 and a user. In some examples, the screen may include a liquid crystal display (LCD) and a touch panel (TP). If the screen includes the touch panel, the screen may be implemented as a touch screen to receive input signals from the user. The touch panel includes at least one touch sensor to sense touch, slide, and gestures on the touch panel. The touch sensor may not only sense boundaries of a touch or slide action, but also detect the wake-up time and pressure associated with the touch or slide action. In some examples, the multimedia component 1408 includes a front camera and/or a rear camera. When the communication device 1400 is in an operation mode, such as a shooting mode or video mode, the front camera and/or the rear camera may receive external multimedia data. Each front camera and each rear camera may be a fixed optical lens system or have focal length and optical zoom capability.

The audio component 1410 is configured to output and/or input audio signals. For example, the audio component 1410 includes a microphone (MIC) that is configured to receive external audio signals when the communication device 1400 is in an operation mode, such as a call mode, a recording mode, and a speech recognition mode. The received audio signals may be further stored in the memory 1404 or sent via the communication component 1416. In some examples, the audio component 1410 also includes a speaker for the output of the audio signals.

The I/O interface 1412 provides an interface between the processing component 1402 and a peripheral interface module, and the peripheral interface module may be a keyboard, a click wheel, buttons, etc. These buttons may include but are not limited to a home button, a volume button, a start button, and a lock button.

The sensor component 1414 includes at least one sensor configured to provide a status assessment of all aspects of the communication device 1400. For example, the sensor component 1414 may detect an on/off state of the communication device 1400, and relative positioning of the components, for example, the component is a display and a keypad of the communication device 1400, and the sensor component 1414 may also detect the change in the position of the communication device 1400 or one of the components of the communication device 1400, presence or absence of contact between the user and the communication device 1400, an orientation or acceleration/deceleration of the communication device 1400 and a temperature change of the communication device 1400. The sensor component 1414 may include a proximity sensor configured to detect presence of nearby objects without any physical contact. The sensor component 1414 may also include an optical sensor, such as a CMOS or CCD image sensors, configured to be used in imaging applications. In some examples, the sensor component 1414 may also include an acceleration sensor, a gyroscope sensor, a magnetic sensor, a pressure sensor or a temperature sensor.

The communication component 1416 is configured to facilitate wired or wireless communication between the communication device 1400 and other devices. The communication device 1400 may access a wireless network based on a communication standard, such as WiFi, 2G or 3G, or a combination of them. In an example, the communication component 1416 receives broadcast signals or broadcast-related information from an external broadcast management system via a broadcast channel. In an example, the communication component 1416 also includes a near-field communication (NFC) module to promote short-range communication. For example, the NFC module may be realized based on a radio frequency identification (RFID) technology, an infrared data association (IrDA) technology, an ultra wideband (UWB) technology, a Bluetooth (BT) technology and other technologies.

In an example, the communication device 1400 may be implemented by at least one application specific integrated circuit (ASIC), a digital signal processor (DSP), a digital signal processing device (DSPD), a programmable logic device (PLD), a field programmable gate array (FPGA), a controller, a microcontroller, a microprocessor, or other electronic elements, configured to execute the above method.

In an example, a non-transitory computer readable storage medium including instructions is also provided, such as a memory 1404 including the instructions, and the above instructions may be executed by a processor 1420 of a communication device 1400 to complete the above method. For example, the non-transitory computer readable storage medium may be an ROM, a random access memory (RAM), a CD-ROM, a magnetic tape, a floppy disk, an optical data storage device, etc.

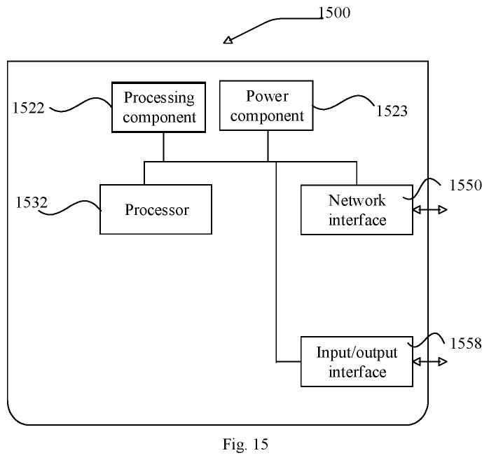

As shown in FIG. 15, an example of the disclosure shows a structure of another communication device. The communication device may be a base station to which the example of the disclosure relates. For example, the communication device 1500 may be provided as a network device. Referring to FIG. 15, the communication device 1500 includes a processing component 1522, which further includes at least one processor, and memory resources represented by a memory 1532, for storing instructions that may be executed by the processing component 1522, such as application programs. The application programs stored in the memory 1532 may include one or more modules each corresponding to a set of instructions. In addition, the processing component 1522 is configured to execute the instructions to execute any method described above applied to the communication device.

The communication device 1500 may also include a power component 1526 configured to execute power management for the communication device 1500, a wired or wireless network interface 1550 configured to connect the communication device 1500 to the network, and an input/output (I/O) interface 1558. The communication device 1500 may operate an operating system stored in the memory 1532, such as Windows Server™, Mac OS X™, Unix™, Linux™, FreeBSD™ or similar.

After considering the specification and the practice of the disclosure disclosed here, those skilled in the art will easily think of other implementation solutions of the disclosure. The disclosure is intended to cover any variation, use or adaptation changes of the disclosure, these variation, use or adaptation changes follow general principles of the disclosure and include common knowledge or customary technical means in the technical field not disclosed in the disclosure. The specification and the examples are merely regarded as examples, and the true scope and spirit of the disclosure are indicated by the claims below.

It is to be understood that the disclosure is not limited to a precise structure already described above and shown in the accompanying drawings, and various modifications and changes may be performed without departing from the scope of the disclosure. The scope of the disclosure is limited merely by the appended claims.

The disclosure provides a low priority uplink information retransmission method and apparatus, a device and a storage medium.

According to a first aspect of examples of the disclosure, a low priority uplink information retransmission method is provided and applied to a base station and includes:
in response to uplink control information (UCI) having a transmission conflict, delivering identifier information of low priority UCI to be retransmitted by a terminal in the UCI having the transmission conflict by using scheduling information of high priority UCI.

In some examples, in response to the UCI having the transmission conflict, delivering the identifier information of the low priority UCI to be retransmitted by the terminal in the UCI having the transmission conflict by using the scheduling information of the high priority UCI includes:
in response to the UCI having the transmission conflict, delivering first downlink control information (DCI) carrying the identifier information of the low priority UCI, where the first DCI is used for scheduling the high priority UCI.

In some examples, the first DCI includes a first downlink assignment index (DAI) field, and the first DAI field is a field added to the first DCI and used for carrying the identifier information of the low priority UCI.

In some examples, the method further includes:
receiving the high priority UCI scheduled based on the first DCI.

In some examples, the method further includes:
delivering second DCI carrying indication information of the low priority UCI to be retransmitted by the terminal, where the second DCI is used for triggering the terminal to retransmit the low priority UCI.

In some examples, the second DCI includes a second DAI field, and the second DAI field is a field added to the second DCI and used for carrying the indication information.

In some examples, the indication information includes at least one of the following:
a number of low priority UCI to be retransmitted by the terminal; or
physical uplink control channel (PUCCH) resource information configured for the low priority UCI to be retransmitted by the terminal.

In some examples, the method further includes:
receiving retransmission information reported by the terminal based on the identifier information, where the retransmission information at least includes the low priority UCI to be retransmitted by the terminal.

In some examples, the retransmission information further includes:
bitmap information corresponding to the low priority UCI to be retransmitted by the terminal, where the bitmap information is used for indicating whether the terminal receives the identifier information of the low priority UCI to be retransmitted by the terminal.

In some examples, a number of characters of the bitmap information is equal to the number of the low priority UCI to be retransmitted by the terminal.

According to a second aspect of the examples of the disclosure, a low priority uplink information retransmission method is provided and applied to a terminal and includes:
receiving identifier information of low priority UCI to be retransmitted by a terminal, delivered through a base station by using scheduling information of high priority UCI, in UCI having a transmission conflict.

In some examples, receiving the identifier information of the low priority UCI to be retransmitted by the terminal, delivered through the base station by using the scheduling information of the high priority UCI, in the UCI having the transmission conflict includes:
receiving first DCI carrying the identifier information of the low priority UCI, where the first DCI is used for scheduling the high priority UCI.

In some examples, the first DCI includes a first DAI field, and the first DAI field is a field added to the first DCI and used for carrying the identifier information corresponding to the low priority UCI.

In some examples, the method further includes:
reporting the high priority UCI based on the first DCI; and
dropping the low priority UCI and using the low priority UCI as the low priority UCI to be retransmitted by the terminal according to the identifier information carried by the first DCI.

In some examples, the method further includes:
receiving second DCI carrying indication information of the low priority UCI to be retransmitted by the terminal, where the second DCI is used for triggering the terminal to retransmit the low priority UCI.

In some examples, the second DCI includes a second DAI field, and the second DAI field is a field added to the second DCI and carries the indication information.

In some examples, the indication information includes at least one of the following:
the number of low priority UCI to be retransmitted by the terminal; or
PUCCH resource information configured for the low priority UCI to be retransmitted by the terminal.

In some examples, the method further includes:
reporting retransmission information based on the identifier information, where the retransmission information at least includes the low priority UCI retransmitted by the terminal.

In some examples, the retransmission information further includes:
bitmap information corresponding to the low priority UCI retransmitted by the terminal, where the bitmap information is used for indicating whether the terminal receives the identifier information of the low priority UCI to be retransmitted by the terminal.

In some examples, the number of characters of the bitmap information is equal to the number of the low priority UCI to be retransmitted by the terminal.

According to a third aspect of the examples of the disclosure, a low priority uplink information retransmission apparatus is provided and applied to a base station and includes:
a first delivering module, configured to in response to uplink control information (UCI) having a transmission conflict, deliver identifier information of low priority UCI to be retransmitted by a terminal in the UCI having the transmission conflict by using scheduling information of high priority UCI.

In some examples, the first delivering module includes:
a delivering submodule, configured to in response to the UCI having the transmission conflict, deliver first DCI carrying the identifier information of the low priority UCI, where the first DCI is used for scheduling the high priority UCI.

In some examples, the first DCI includes a first DAI field, and the first DAI field is a field added to the first DCI and used for carrying the identifier information of the low priority UCI.

In some examples, the apparatus further includes:
a first receiving module, configured to receive the high priority UCI scheduled based on the first DCI.

In some examples, the apparatus further includes:
a second delivering module, configured to deliver second DCI carrying indication information of the low priority UCI to be retransmitted by the terminal, where the second DCI is used for triggering the terminal to retransmit the low priority UCI.

In some examples, the second DCI includes a second DAI field, and the second DAI field is a field added to the second DCI and used for carrying the indication information.

In some examples, the indication information includes at least one of the following:
the number of low priority UCI to be retransmitted by the terminal; or
PUCCH resource information configured for the low priority UCI to be retransmitted by the terminal.

In some examples, the apparatus further includes:
a second receiving module, configured to receive retransmission information reported by the terminal based on the identifier information, where the retransmission information at least includes the low priority UCI to be retransmitted by the terminal.

In some examples, the retransmission information further includes:
bitmap information corresponding to the low priority UCI to be retransmitted by the terminal, where the bitmap information is used for indicating whether the terminal receives the identifier information corresponding to the low priority UCI to be retransmitted by the terminal.

In some examples, the number of characters of the bitmap information is equal to the number of the low priority UCI to be retransmitted by the terminal.

According to a fourth aspect of the examples of the disclosure, a low priority uplink information retransmission apparatus is provided and applied to a terminal and includes:
a third receiving module, configured to receive identifier information of low priority UCI to be retransmitted by a terminal, delivered through a base station by using scheduling information of high priority UCI, in UCI having a transmission conflict.

In some examples, the third receiving module includes:
a receiving submodule, configured to receive first DCI carrying the identifier information of the low priority UCI, where the first DCI is used for scheduling the high priority UCI.

In some examples, the first DCI includes a first DAI field, and the first DAI field is a field added to the first DCI and used for carrying the identifier information corresponding to the low priority UCI.

In some examples, the apparatus further includes:
a first reporting module, configured to report the high priority UCI based on the first DCI; and
a dropping module, configured to drop the low priority UCI and use the low priority UCI as the low priority UCI to be retransmitted by the terminal according to the identifier information carried by the first DCI.

In some examples, the apparatus further includes:
a fourth receiving module, configured to receive second DCI carrying indication information of the low priority UCI to be retransmitted by the terminal, where the second DCI is used for triggering the terminal to retransmit the low priority UCI.

In some examples, the second DCI includes a second DAI field, and the second DAI field is a field added to the second DCI and carries the indication information.

In some examples, the indication information includes at least one of the following:
the number of low priority UCI to be retransmitted by the terminal; or
PUCCH resource information configured for the low priority UCI to be retransmitted by the terminal.

In some examples, the apparatus further includes:
a second reporting module, configured to report retransmission information based on the identifier information, where the retransmission information at least includes the low priority UCI retransmitted by the terminal.

In some examples, the retransmission information further includes:
bitmap information corresponding to the low priority UCI retransmitted by the terminal, where the bitmap information is used for indicating whether the terminal receives the identifier information of the low priority UCI to be retransmitted by the terminal.

In some examples, the number of characters of the bitmap information is equal to the number of the low priority UCI to be retransmitted by the terminal.

According to a fifth aspect of the examples of the disclosure, a device is provided, and at least includes a processor and a memory configured to store an executable instruction able to operate on the processor, where
when the processor is configured to operate the executable instruction, the executable instruction executes steps in the above any low priority uplink information retransmission method.

According to a sixth aspect of the examples of the disclosure, a non-transitory computer readable storage medium is provided, where the computer readable storage medium stores a computer executable instruction, and when the computer executable instruction is executed by a processor, steps in the above any low priority uplink information retransmission method are implemented.

The examples of the disclosure provide the low priority uplink information retransmission method and apparatus, the device and the storage medium. Through technical solutions of the examples of the disclosure, when there is the UCI having the transmission conflict, the base station may inform UE the identifier information of the UCI needing to be retransmitted, so as to facilitate retransmission of the UCI by the UE. Accordingly, on one hand, the base station and the UE have consistent information about whether there is the transmission conflict and which UCI needs the UE to perform retransmission, so as to reduce information missing caused by information inconsistency; and on the other hand, the UE conveniently retransmits the UCI based on instructions of the base station, compared with retransmitting information of all processes at a time, the redundancy of retransmission information is reduced, and resources are saved.

1. A low priority uplink information retransmission method, comprising:
in response to uplink control information (UCI) having a transmission conflict, delivering identifier information of a low priority UCI to be retransmitted by a terminal in the UCI having the transmission conflict by using scheduling information of a high priority UCI.

2. The method according to claim 1, wherein in response to the uplink control information (UCI) having the transmission conflict, delivering the identifier information of the low priority UCI to be retransmitted by the terminal in the UCI having the transmission conflict by using the scheduling information of the high priority UCI comprises:
in response to the UCI having the transmission conflict, delivering first downlink control information (DCI) carrying the identifier information of the low priority UCI, wherein the first DCI is used for scheduling the high priority UCI.

3. The method according to claim 2, wherein the first DCI comprises a first downlink assignment index (DAI) field, and the first DAI field is a field added to the first DCI and used for carrying the identifier information of the low priority UCI.

4. The method according to claim 2, further comprising:
receiving the high priority UCI scheduled based on the first DCI.

5. The method according to claim 1, further comprising:
delivering second DCI carrying indication information of the low priority UCI to be retransmitted by the terminal, wherein the second DCI is used for triggering the terminal to retransmit the low priority UCI; wherein
the second DCI comprises a second DAI field, and the second DAI field is a field added to the second DCI and used for carrying the indication information.

6. (canceled)

7. The method according to claim 5, wherein the indication information comprises at least one of:
a number of low priority UCI to be retransmitted by the terminal; or
physical uplink control channel (PUCCH) resource information configured for the low priority UCI to be retransmitted by the terminal.

8. The method according to any one of claim 1, further comprising:
receiving retransmission information reported by the terminal based on the identifier information, wherein the retransmission information at least comprises the low priority UCI to be retransmitted by the terminal; wherein
the retransmission information further comprises:
bitmap information corresponding to the low priority UCI to be retransmitted by the terminal, wherein the bitmap information is used for indicating whether the terminal receives the identifier information of the low priority UCI to be retransmitted by the terminal.

9. (canceled)

10. The method according to claim 98, wherein a number of characters of the bitmap information is equal to the number of the low priority UCI to be retransmitted by the terminal.

11. A low priority uplink information retransmission method, comprising:
receiving identifier information of a low priority UCI to be retransmitted by a terminal, delivered through a base station by using scheduling information of a high priority UCI, in UCI having a transmission conflict.

12. The method according to claim 11, wherein receiving the identifier information of the low priority UCI to be retransmitted by the terminal, delivered through the base station by using the scheduling information of the high priority UCI, in the UCI having the transmission conflict comprises:
receiving first DCI carrying the identifier information of the low priority UCI, wherein the first DCI is used for scheduling the high priority UCI.

13. The method according to claim 12, wherein the first DCI comprises a first downlink assignment index (DAI) field, and the first DAI field is a field added to the first DCI and used for carrying the identifier information corresponding to the low priority UCI.

14. The method according to claim 12, further comprising:
reporting the high priority UCI based on the first DCI; and
dropping the low priority UCI and using the low priority UCI as the low priority UCI to be retransmitted by the terminal according to the identifier information carried by the first DCI.

15. The method according to claim 11, further comprising:
receiving second DCI carrying indication information of the low priority UCI to be retransmitted by the terminal, wherein the second DCI is used for triggering the terminal to retransmit the low priority UCI; wherein
the second DCI comprises a second DAI field, and the second DAI field is a field added to the second DCI and carries the indication information.

16. (canceled)

17. The method according to claim 15, wherein the indication information comprises at least one of:
a number of low priority UCI to be retransmitted by the terminal; or
PUCCH resource information configured for the low priority UCI to be retransmitted by the terminal.

18. The method according to claim 11, further comprising:
reporting retransmission information based on the identifier information, wherein the retransmission information at least comprises the low priority UCI retransmitted by the terminal;
wherein
the retransmission information further comprises:
bitmap information corresponding to the low priority UCI retransmitted by the terminal, wherein the bitmap information is used for indicating whether the terminal receives the identifier information of the low priority UCI to be retransmitted by the terminal.

19. (canceled)

20. The method according to claim 18, wherein a number of characters of the bitmap information is equal to the number of the low priority UCI to be retransmitted by the terminal.

21-40. (canceled)

41. A device comprising:
a processor, and
a memory configured to store an executable instruction able to operate on the processor, wherein the processor is configured to:
in response to uplink control information (UCI) having a transmission conflict, deliver identifier information of a low priority UCI to be retransmitted by a terminal in the UCI having the transmission conflict by using scheduling information of a high priority UCI.

42. A non-transitory computer readable storage medium, wherein the non-transitory computer readable storage medium stores a computer executable instruction, and in response to determining that the computer executable instruction is executed by a processor, steps in the low priority uplink information retransmission method provided according to claim 1 is implemented.

43. A device comprising
a processor; and
a memory configured to store an executable instruction,
wherein the executable instruction when executed by the processor causes the processor to execute the method according to claim 11.

44. A non-transitory computer readable storage medium, wherein the non-transitory computer readable storage medium stores a computer executable instruction that when executed by a processor causes the processor to execute the method according to claim 11.
